(19) United States
(12) Patent Application Publication
(10) Pub. No.: US 2010/0080634 A1
(43) Pub. Date: Apr. 1, 2010

(54) FIXING DEVICE AND FIXING METHOD, AND IMAGE FORMING APPARATUS

(76) Inventor: Takahiko KIMURA, Osaka-shi (JP)

Correspondence Address: NIXON & VANDERHYE, PC, 901 NORTH GLEBE ROAD, 11TH FLOOR, ARLINGTON, VA, 22203, US

(21) Appl. No.: 12/564,336

(22) Filed: Sep. 22, 2009

(30) Foreign Application Priority Data
Sep. 30, 2008 (JP) P2008-255746

(51) Int. Cl. G03G 15/20; G03G 13/20

(52) U.S. Cl. 399/329; 430/124.32

(57) ABSTRACT

Provided is a fixing device capable of preventing occurrence of a hot-offset phenomenon even with use of a low-temperature fixable toner. In the fixing device, the first, second heater lamp heats the first, second fixing belt to a predetermined temperature which is higher than or equal to the melting point of the crystalline polyester contained in the toner constituting a toner image borne on a recording paper sheet, whereupon the toner image is fused into place. Then, first and second cooling portions respectively cool the first and second fixing belts down to a predetermined temperature which is higher than or equal to the melting point of the release agent contained in the toner constituting the toner image but lower than the melting point of the crystalline polyester.

### CROSS-REFERENCE TO RELATED APPLICATION

This application claims priority to Japanese Patent Application No. 2008-255746, which was filed on Sep. 30, 2008, the contents of which are incorporated herein by reference in their entirety.

### BACKGROUND OF THE INVENTION

1. Field of the Invention

The present invention relates to a fixing device, a fixing method using the fixing device, and an electrophotographic image forming apparatus equipped with the fixing device.

2. Description of the Related Art

A fixing device constituted for use in an electrophotographic image forming apparatus, such as a copying machine and a printer, comprises an upper fixing belt and a lower fixing belt (or a lower fixing roller) that are kept in contact with each other under pressure. In such a fixing device, the upper fixing belt is heated to a predetermined temperature (fixing temperature) by a heating portion which is constructed for example of a halogen lamp and is disposed inside the upper fixing belt. In this state, a recording paper sheet having a yet-to-be-fixed toner image formed thereon is caused to pass through a region where the upper fixing belt and the lower fixing belt (or the lower fixing roller) make pressure-contact with each other (fixing nip region), whereupon the toner image is fixed onto the recording paper sheet under application of heat and pressure.

In the fixing device employing the fixing belt, since as long a fixing-nip region length as possible can be secured, it follows that heat energy is transmitted readily to the yet-to-be-fixed toner borne on the recording paper sheet. This makes it possible to attain excellent fixability. However, if the yet-to-be-fixed toner borne on the recording paper sheet is heated excessively, a hot-offset phenomenon could occur.

As an attempt to solve such a problem, for example, a fixing device provided with a fan for cooling a fixing belt is disclosed in Japanese Unexamined Patent Publication JP-A 4-216579 (1992). In the fixing device disclosed in JP-A 4-216579, after a yet-to-be-fixed toner borne on a recording paper sheet is fused under application of heat, the fixing belt is cooled down by the fan, whereby the toner undergoes cooling. In this way, occurrence of a hot-offset phenomenon can be prevented.

In keeping up with the demand for energy conservation, development has been under way to come up with a toner which can be fixed into place at a low temperature. Such a low-temperature fixable toner contains, as a binder resin, crystalline polyester and amorphous polyester. Although a toner containing crystalline polyester is fused at a relatively low temperature and exhibits high fixing strength, it is prone to a hot-offset phenomenon.

### SUMMARY OF THE INVENTION

Accordingly, an object of the invention is to provide a fixing device and a fixing method that succeed in preventing occurrence of a hot-offset phenomenon even with use of a low-temperature fixable toner. Another object of the invention is to provide an image forming apparatus equipped with the fixing device.

The invention provides a fixing device for fixing a toner image, which is formed on a recording medium in a yet-to-be-fixed state and is constituted by a toner containing a binder resin composed of crystalline polyester and amorphous polyester and a release agent having a melting point lower than a melting point of the crystalline polyester, onto the recording medium by bringing about toner-image fusion, comprising: a fixing belt disposed face to face with a surface of the recording medium having the toner image formed thereon, the fixing belt being an endless belt member which is supported around a plurality of support rollers with tension so as to be driven to turn in accompaniment with a rotation of the support rollers;

a heating portion for applying heat to the fixing belt from the inside so that a surface temperature of the fixing belt becomes a predetermined temperature which is higher than or equal to a melting point of the crystalline polyester; and

a cooling portion located downstream from the heating portion with respect to a direction in which the fixing belt turns, for providing cooling for the fixing belt from the inside so that the surface temperature of the fixing belt becomes a predetermined temperature which is higher than or equal to a melting point of the release agent but lower than the melting point of the crystalline polyester,

the fixing device fixing the yet-to-be-fixed toner image borne on the recording medium into place in a fixing nip region created between the heating portion and the cooling portion in the turning direction of the fixing belt.

According to the invention, there is provided a fixing device for fixing a toner image onto a recording medium by bringing about toner-image fusion. The toner image is constituted by a toner containing a binder resin composed of crystalline polyester and amorphous polyester and a release agent having a melting point lower than the melting point of the crystalline polyester. In the fixing device embodying the invention, the heating portion applies heat to the fixing belt disposed face to face with the toner image-bearing surface of the recording medium so that the surface temperature of the fixing belt becomes the predetermined temperature which is higher than or equal to the melting point of the crystalline polyester. In this way, the toner constituting the toner image borne on the recording medium is fused, so that the yet-to-be-fixed toner image borne on the recording medium can be fixed into place in the fixing nip region created between the heating portion and the cooling portion in the turning direction of the fixing belt. Then, the cooling portion provides cooling for the fixing belt so that the surface temperature of the fixing belt becomes the predetermined temperature which is higher than or equal to the melting point of the release agent but lower than the melting point of the crystalline polyester.

The cooling portion provides cooling for the fixing belt so that the surface temperature of the fixing belt becomes a temperature lower than the melting point of the crystalline polyester. This makes it possible to solidify the toner constituting the toner image borne on the recording medium in a fused state through application of heat by the heating portion, and thereby prevent occurrence of a hot-offset phenomenon. Moreover, since the surface temperature of the fixing belt cooled down by the cooling portion is higher than or equal to the melting point of the release agent, it is possible to impart releasability to the toner constituting the toner image. Accordingly, the toner image can be prevented from adhering to the fixing belt, in consequence whereof there results no hot-offset phenomenon.

Moreover, in the invention, it is preferable that the cooling portion is constructed of a Peltier element, and the fixing belt is heated by the heating portion with the exploitation of exothermic energy corresponding to the cooling energy produced from the cooling portion.

According to the invention, the cooling portion is constructed of a Peltier element. The fixing device is so constituted that the fixing belt is heated by the heating portion with the exploitation of exothermic energy corresponding to the cooling energy produced from the cooling portion. The Peltier element is a semiconductor element which involves the Peltier effect. That is, when electric current is passed through a part of connection between two of metal plates, heat is transferred from one of the metal plates to the other. This phenomenon is known as the Peltier effect. In the cooling portion, the fixing belt is cooled down by the heat-absorbing metal plate (hereafter referred to as “heat absorbing surface”) of the Peltier element. At this time, the exothermic energy corresponding to the cooling energy produced from the heat-generating metal plate (hereafter referred to as “heat generating surface”) of the Peltier element can be effectively utilized as heat energy for heating the fixing belt. This leads to a reduction in energy consumption.

Moreover, in the invention, it is preferable that the heating portion is disposed within, out of a plurality of the support rollers for supporting the fixing belt therearound with tension, the one disposed on the most upstream side with respect to the turning direction of the fixing belt.

According to the invention, the heating portion is disposed within, out of a plurality of the support rollers for supporting the fixing belt therearound with tension, the one disposed on the most upstream side with respect to the turning direction of the fixing belt. This makes it possible to accumulate heat energy produced by the heating portion in the support roller interiorly thereof. Accordingly, upon a restart of the operation of the fixing device after a halt, the surface temperature of the fixing belt can be adjusted to be a predetermined temperature at once.

Moreover, in the invention, it is preferable that the fixing device further comprises a heat insulating member extending in an extending direction of the fixing belt, for covering the fixing belt from its outside.

According to the invention, the fixing device further comprises a heat insulating member extending in an extending direction of the fixing belt, for covering the fixing belt from its outside. This makes it possible to prevent the heat given off by the fixing belt heated by the heating portion from escaping out of the fixing device. Accordingly, upon a restart of the operation of the fixing device after a halt, the surface temperature of the fixing belt can be adjusted to be a predetermined temperature at once.

Moreover, in the invention, it is preferable that the fixing device further comprises a second cooling portion disposed face to face with the cooling portion, with the fixing belt interposed therebetween, for providing cooling for the fixing belt from its outside so that the surface temperature of the fixing belt becomes a predetermined temperature which is higher than or equal to the melting point of the release agent but lower than the melting point of the crystalline polyester.

According to the invention, the fixing device further comprises a second cooling portion disposed face to face with the cooling portion, with the fixing belt interposed therebetween. The second cooling portion provides cooling for the fixing belt from its outside so that the surface temperature of the fixing belt becomes the predetermined temperature which is higher than or equal to the melting point of the release agent but lower than the melting point of the crystalline polyester. In this construction, the fixing belt is cooled down from the inside by the cooling portion, and is also cooled down from its outside by the second cooling portion. This makes it possible to cool the fixing belt down to the predetermined temperature at a higher cooling rate.

The invention provides a fixing method for fixing a toner image on a recording medium by using the fixing device as set forth hereinabove.

According to the invention, there is provided a fixing method for fixing a toner image on a recording medium by using the fixing device as set forth hereinabove. As the fixing belt is turned, a recording medium having a yet-to-be-fixed toner image formed thereon is conveyed while making contact with the fixing belt, and the toner constituting the toner image is melted by being heated to the predetermined temperature higher than or equal to the melting point of the crystalline polyester by the heating portion. Thereby, the toner is fixed onto the recording medium. Then, the toner in a fused state through application of heat by the heating portion is solidified by being cooled down to a temperature lower than the melting point of the crystalline polyester by the cooling portion. Accordingly, it is possible to achieve toner image fixation on the recording medium while preventing occurrence of a hot-offset phenomenon.

The invention further provides an image forming apparatus provided with the fixing device as set forth hereinabove.

According to the invention, there is realized the image forming apparatus equipped with the fixing device. By virtue of the provision of the fixing device capable of preventing occurrence of a hot-offset phenomenon, the image forming apparatus succeeds in producing high-quality images.

### BRIEF DESCRIPTION OF THE DRAWINGS

Other and further objects, features, and advantages of the invention will be more explicit from the following detailed description taken with reference to the drawings wherein:

FIG. 1 is a view showing the structure of an image forming apparatus in accordance with an embodiment of the invention;

FIG. 2 is a view showing the structure of a fixing device in accordance with a first embodiment of the invention;

FIG. 3 is a view showing the configuration of a temperature control unit of the fixing device; and

FIG. 4 is a view showing the structure of a fixing device in accordance with a second embodiment of the invention.

### DETAILED DESCRIPTION OF THE PREFERRED EMBODIMENTS

Now referring to the drawings, preferred embodiments of the invention will be described in detail.

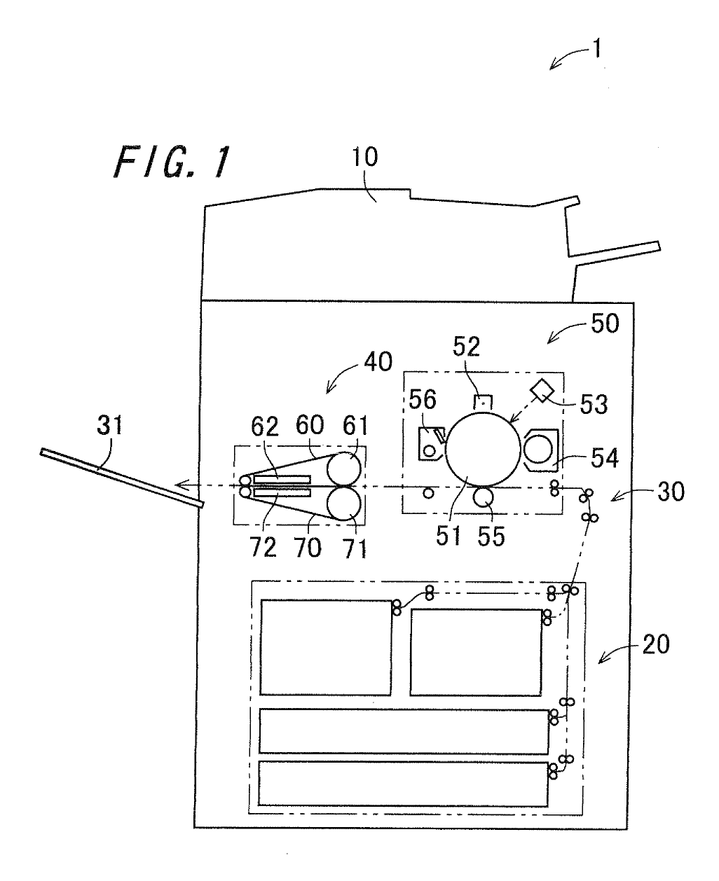

FIG. 1 is a view showing the structure of an image forming apparatus 1 in accordance with an embodiment of the invention. In this embodiment, the image forming apparatus 1 is built as a xerographic multi-function printer for forming a color image or monochrome image on a recording medium (recording paper sheet) on the basis of image data transmitted from a scanner unit 10 or each terminal equipment connected thereto over a network. The image forming apparatus 1 includes the scanner unit 10, an image forming unit 50, a fixing device 40, a paper feeding unit 20, a paper conveying section 30, and a paper output tray 31.

The scanner unit 10 effects reading of an image of an original manuscript. The scanner unit 10 includes platen glass, an exposure lamp, a reflection mirror, an imaging lens, and a CCD (Charge Coupled Device) image sensor that are not shown. In the scanner unit 10, the exposure lamp comes on to light the surface of the manuscript through the platen glass, and the reflection mirror directs the light reflected from the manuscript to the imaging lens. Then, the imaging lens condenses the light reflected from the manuscript on the CCD, whereby the image borne on the surface of the manuscript is focused onto the CCD image sensor. In this way, the scanner unit 10 reads the image of the manuscript. Upon the reading of the image of the manuscript by the scanner unit 10, image data indicating the image of the manuscript is inputted to a control section such as a microcomputer. The image data is subjected to various image processing treatments, and is whereafter outputted to the image forming unit 50.

The image forming unit 50 includes a photoreceptor drum 51, a charging device 52, a laser scanner unit (LSU) 53, a developing unit 54, a transfer roller 55, and a cleaning device 56. The charging device 52, the dove roping unit 54, the transfer roller 55, and the cleaning device 56 are arranged about the photoreceptor drum 51 in the order named in a direction in which the photoreceptor drum 51 is rotated.

The photoreceptor drum 51, which is so supported that it can be driven to rotate about its axis by a non-illustrated driving portion, includes a conductive substrate and an organic photosensitive layer formed on the surface of the conductive substrate that are not shown. As the conductive substrate and the organic photosensitive layer, any of those used customarily in the relevant field can be used. It is also possible to use a photoreceptor drum having an inorganic photosensitive layer made, for example, of silicon formed thereon.

The charging device 52 is disposed face to face with the photoreceptor drum 51 so as to be spaced away from the surface of the photoreceptor drum 51 along the direction of the length of the photoreceptor drum 51. By the charging device 52, the surface of the photoreceptor drum 51 is charged to a predetermined potential with a predetermined polarity. As the charging device 52, for example, a scorotron charger, a corotron charger, and a contact type charger using a charging roller or charging brush are suited for use.

The LSU 53, which is a laser exposure device, performs light exposure by a laser scanning technique in accordance with the image data in a manner to change the surface potential of the photoreceptor drum 51 that has been charged by the charging device 52. In this way, there is formed an electrostatic latent image corresponding to the image data.

The developing unit 54, which is disposed face to face with the photoreceptor drum 51, supplies a developer to the surface of the photoreceptor drum 51 having the electrostatic latent image formed thereon to thereby develop the electrostatic latent image into a toner image. As the developer, for example, a non-magnetic one-component developer formed of a non-magnetic toner, a non-magnet two-component developer formed of a non-magnetic toner and a carrier, and a magnetic developer formed of a magnetic toner are suited for use.

Now, a description will be given below as to a developer which is used for the invention.

### (Toner)

In the invention, the toner which is supplied by the developing unit 54 contains a binder resin composed of crystalline polyester and amorphous polyester and a release agent having a melting point lower than the melting point of the crystalline polyester, and also contains, as additives, a colorant and a charge control agent.

<Binder Resin>

The toner contains crystalline polyester and amorphous polyester acting as a binder resin. “Crystalline polyester” refers to polyester having an index of crystallinity in a range of from 0.6 to 1.5, preferably an index of crystallinity in a range of from 0.6 to 1.2. On the other hand, “amorphous polyester” refers to polyester having an index of crystallinity which is greater than 1.5 or less than 0.6, preferably an index of crystallinity greater than 1.5. An index of crystallinity, which is a physical property (value) indicative of the degree of crystallinity in resin, is defined by a ratio of a softening point to the highest temperature of endothermic peak, i.e., (softening point)/(highest temperature of endothermic peak). A resin having an index of crystallinity greater than 1.5 is of amorphous nature, whereas a resin having an index of crystallinity less than 0.6 is low in crystallinity; that is, much of the portions thereof are of amorphous nature. The degree of crystallinity can be controlled by making adjustment to the kinds of raw material monomers and the ratio thereof, preparation conditions (for example, reaction temperature, reaction time, and cooling rate), and so forth. Note that the highest temperature of endothermic peak refers to the temperature of, out of endothermic peaks observed, the one at the highest temperature point. When a difference between the highest temperature of endothermic peak and the softening point is 20° C. or lower, then the peak temperature is defined as a melting point. When the difference between the highest temperature of endothermic peak and the softening point exceeds 20° C., then the peak temperature is determined to be ascribable to glass transition.

In accordance with heretofore known methods, for example, the method disclosed in Japanese Unexamined Patent Publication JP-A 2006-113473, the crystalline polyester and the amorphous polyester are produced through condensation polymerization of an alcohol component and a carboxylic acid component used as raw material monomers.

It is preferable that the alcohol component constituting the crystalline polyester contains a monomer capable of promoting resin crystallinity, such as aliphatic diol ranging in carbon atom number from 2 to 8.

The examples of aliphatic diol ranging in carbon atom number from 2 to 8 include ethylene glycol, 1,2-propylene glycol, 1,3-propylene glycol, 1,4-butanediol, 1,5-pentanediol, 1,6-hexanediol, 1,7-heptanediol, 1,8-octanediol, neopentyl glycol, and 1,4-butenediol. In particular, α,ω-linear alkane diol is desirable.

It is preferable that the aliphatic dial ranging in carbon atom number from 2 to 8 is contained in the alcohol component in an amount of 80% or above by mole from the standpoint of attaining high crystallinity. Moreover, it is preferable that aliphatic dial of one constitutes 70% or above by mole of the entire alcohol component.

The examples of the carboxylic acid component include: aliphatic dicarboxylic acids ranging in carbon atom number from 2 to 30, preferably from 2 to 8, such as a fumaric acid, an adipic acid, an oxalic acid, a malonic acid, a maleic acid, a citraconic acid, an itaconic acid, a glutaconic acid, a succinic acid, a sebacic acid, an azelaic acid, a n-dodecyl succinic acid, and a n-dodecenyl succinic acid; aromatic dicarboxylic acids such as a phthalic acid, an isophthalic acid, and a terephthalic acid; alicyclic dicarboxylic acids such as a cyclohexane dicarboxylic acid; and tricarboxylic or higher carboxylic acids such as a trimellitic acid and a pyromellitic acid. Among them, in view of high degree of crystallinity, aliphatic dicarboxylic acids are desirable, and aliphatic dicarboxylic acids ranging in carbon atom number from 2 to 8 are particularly desirable. Note that the carboxylic acid component may contain a carboxylic acid, an anhydride thereof, and alkyl (1 to 3 in carbon atom number) ester thereof. Among them, a carboxylic acid is desirable. It is preferable that an aliphatic dicarboxylic acid compound is contained in the carboxylic acid component in an amount of 70% or above by mole.

In regard to a mole ratio between the carboxylic acid component and the alcohol component (carboxylic acid component/alcohol component) in the crystalline polyester, in order to provide crystalline polyester of higher molecular weight, it is preferable that the alcohol component is larger in content than the carboxylic acid component. Moreover, from the standpoint of adjusting polyester molecular weight with ease by distilling the alcohol component out under decompressional reaction, it is preferable that the mole ratio is greater than or equal to 0.9 but less than 1. In the formation of the crystalline polyester, the condensation polymerization of the alcohol component and the carboxylic acid component can be effected, for example, at a temperature in a range of from 120 to 230° C. in an inert gas atmosphere, and in the presence of an esterification catalyst as desired.

Moreover, in view of low-temperature fixability, it is preferable that the crystalline polyester has a melting point (the highest temperature of endothermic peak) in a range of from 80 to 130° C. and a softening point in a range of from 100 to 150° C.

The examples of the alcohol component constituting the amorphous polyester include: aromatic dials, for example an alkylene oxide adduct of bisphenol A such as polyoxypropylene(2,2)-2,2-bis(4-hydroxyphenyl)propane and polyoxyethylene(2,2)-2,2-bis(4-hydroxyphenyl)propane; aliphatic diols such as ethylene glycol and propylene glycol; and trihydric or higher alcohols such as glycerin and pentaerythritol.

Among the aforementioned alcohol components, a monomer capable of promoting resin amorphousness, for example aromatic dials such as an alkylene oxide adduct bisphenol A is suited for use. Moreover, in view of chargeability, the alkylene oxide adduct of bisphenol A is contained in the alcohol component in an amount of preferably 50% or above by mole, and more preferably 70% or above by mole, and still more preferably 90% or above by mole.

Moreover, the examples of the carboxylic acid component include: aromatic dicarboxylic acids such as a phthalic acid, an isophthalic acid, and a terephthalic acid; aliphatic dicarboxylic acids such as an oxalic acid, a malonic acid, a maleic acid, a fumaric acid, a citraconic acid, an itaconic acid, a glutaconic acid, a succinic acid, an adipic acid, a sebacic acid, an azelaic acid, a n-dodecyl succinic acid, and a n-dodecenyl succinic acid; alicyclic dicarboxylic acids such as a cyclohexane dicarboxylic acid; tricarboxylic or higher carboxylic acids such as a trimellitic acid and a pyromellitic acid; and anhydrides and alkyl (1 to 3 in carbon atom number) ester of those acids. Among them, in view of chargeability, an aromatic carboxylic acid compound is desirable. In view of crystalline polyester dispersibility, an aliphatic carboxylic acid compound is desirable, and in particular a fumaric acid is desirable. Note that, in the invention, “carboxylic acid compound” refers to dicarboxylic acids, and anhydrides and alkyl (1 to 3 in carbon atom number) ester thereof.

In the formation of the amorphous polyester, the condensation polymerization of the alcohol component and the carboxylic acid component can be effected, for example, at a temperature in a range of from 180 to 250° C. in an inert gas atmosphere, and in the presence of an esterification catalyst as desired.

Moreover, it is preferable that the amorphous polyester has a softening point in a range of from 80 to 150° C. Further, from the standpoint of achieving both low-temperature fixability and offset resistance, the amorphous polyester is preferably composed of two of amorphous polyester substances having different softening points, and the difference in softening point therebetween is preferably greater than or equal to 10° C., and more preferably falls in a range of from 20 to 60° C. In this case, the lower-softening-point polyester preferably has a softening point in a range of from 80 to 120° C. from the low-temperature fixability standpoint, whereas the higher-softening-point polyester preferably has a softening point in a range of from 120 to 150° C. from the offset resistance standpoint. It is preferable that the ratio in weight of the higher-softening-point polyester to the lower-softening-point polyester (higher-softening-point polyester/lower-softening-point polyester) falls in a range of from 20/80 to 80/20.

Moreover, the acid value of the amorphous polyester preferably falls in a range of from 1 to 50 mgKOH/g, and more preferably falls in a range of from 10 to 30 mgKOH/g. Further, in view of crushability and storage stability, it is preferable that the glass transition temperature of the amorphous polyester falls in a range of from 40 to 80° C.

Moreover, in view of crystalline polyester dispersibility, it is desirable to use a compound of at least one as a common raw material monomer for the crystalline polyester and the amorphous polyester. Such a common compound should preferably be a carboxylic acid component. From the standpoint of increasing the degree of crystallinity of the crystalline polyester, a fumaric acid and a phthalic acid are preferable for use, and a fumaric acid is particularly desirable.

In view of low-temperature fixability and storage stability, the crystalline polyester is contained in toner particles in an amount of preferably 3 to 40% by weight, and more preferably 5 to 30% by weight. Moreover, the ratio in weight between the crystalline polyester and the amorphous polyester (crystalline polyester/amorphous polyester) preferably falls in a range of from 3/97 to 50/50, and more preferably in a range of from 5/95 to 35/65.

<Release Agent>

The release agent contained in the toner used for the invention is added to impart releasability to the toner at the time when it is fixed onto a recording paper sheet. The examples of the release agent include: synthetic waxes such as a polypropylene wax and a polyethylene wax; plant-derived waxes such as a carnauba wax, a rice wax, and a candelilla wax; and paraffin waxes (HNP-3, HNP-5, HNP-10, HNP-11, HNP-12, HNP-51, etc. manufactured by NIPPON SEIRO Co., Ltd.). Note that the release agent for use has to have a melting point lower than the melting point of the crystalline polyester. It is preferable that the melting point of the release agent falls in a range of from 65 to 100° C.

<Colorant>

As the colorant, heretofore known pigments and dyestuffs generally used for toner application can be used. To be specific, as a colorant for black toner, carbon black, magnetite, and the like are suited for use.

The examples of a colorant for yellow toner include: arylamide acetoacetate-based monoazo yellow pigments such as C.I. Pigment Yellow 1, C.I. Pigment Yellow 3, C.I. Pigment Yellow 74, C.I. Pigment Yellow 97, and C.I. Pigment Yellow 98; arylamide acetoacetate-based disazo yellow pigments such as C.I. Pigment Yellow 12, C.I. Pigment Yellow 13, C.I. Pigment Yellow 14, and C.I. Pigment Yellow 17; condensed monoazo-based yellow pigments such as C.I. Pigment Yellow 93 and C.I. Pigment Yellow 155; yellow pigments of other types such as C.I. Pigment Yellow 180, C.I. Pigment Yellow 150, and C.I. Pigment Yellow 185; and yellow dyestuffs such as C.I. Solvent Yellow 19, C.I. Solvent Yellow 77, C.1. Solvent Yellow 79, and C.I. Disperse Yellow 164.

The examples of a colorant for magenta toner include: red or vermilion pigments such as C.I. Pigment Red 48, C.I. Pigment Red 49:1, C.I. Pigment Red 53:1, C.I. Pigment Red 57, C.I. Pigment Red 57:1, C.I. Pigment Red 81, C.I. Pigment Red 122, C.I. Pigment Red 5, C.I. Pigment Red 146, C.I. Pigment Red 184, C.I. Pigment Red 238, and C.I. Pigment Violet 19; and red dyestuffs such as C.I.

Solvent Red 49, C.I. Solvent Red 52, C.I. Solvent Red 58, and C.I. Solvent Red 8.

The examples of a colorant for cyan toner include: copper phthalocyanine and its derivative-based blue dyes and pigments such as C.I. Pigment Blue 15:3 and C.I. Pigment Blue 15:4; and green pigments such as C.I. Pigment Green 7 and C.I. Pigment Green 36 (phthalocyanine green), The colorant is added in an amount of preferably ca. 1 to 15 parts by weight, and more preferably 2 to 10 parts by weight, based on 100 parts by weight of the binder resin.

<Charge Control Agent>

The charge control agent is added to impart desirable chargeability to the toner. As the charge control agent applicable for the toner of the invention, charge control agents for positive charge control or charge control agents for negative charge control can be used. The examples of the charge control agent for negative charge control include: a chromium azo complex dye; an iron azo complex dye; a cobalt azo complex dye; metal (chromium, zinc, aluminum, boron) complex or salt compounds of salicylic acid or salicylic acid derivatives; metal (chromium, zinc, aluminum, boron) complex or salt compounds of naphthol acid or naphthol acid derivatives; metal (chromium, zinc, aluminum, boron) complex or salt compounds of benzilic acid or benzilic acid derivatives; long-chain alkyl carboxylate; and long-chain alkyl sulfonate.

The examples of the charge control agent for positive charge control include a nigrosine dye and its derivatives, triphenyl methane derivatives, and derivatives of quaternary ammonium salts, quaternary phosphonium salts, quaternary pyridinium salts, guanidine salts, and amidine salts. The amount of addition of such a charge control agent should preferably fall in a range of from 0.1 to 20 parts by weight, and more preferably 0.5 to 10 parts by weight, based on 100 parts by weight of the binder resin.

Next, a description will be given below as to a method for manufacturing the toner used for the invention. The toner used for the invention can be produced by heretofore known methods such as a kneading-pulverization technique and an agglomeration technique. For example, according to the kneading-pulverization technique, firstly, the binder resin, the release agent, the colorant, and the charge control agent are mixed together by an airflow mixer such as HENSCHEL MIXER or SUPERMIXER. The resultant raw material admixture is kneaded at a temperature of approximately 100 to 180° C. by a melting-kneading machine such as a twin-screw kneader or open roll-type kneader. The resultant kneaded product is subjected to cooling solidification treatment, and the resultant solid product is crushed by an air pulverizer such as a jet mill. Then, on an as needed basis, the thus obtained particles are subjected to particle size adjustment such as a classification treatment. In this way, the toner used for the invention can be produced.

It is preferable that the particle size of toner particles constituting the toner falls in a range of from 4 to 7 μm. As employed herein, the particle size refers to the volume average particle size measured by Coulter Counter manufactured by Beckman Coulter, Inc. using a 100-μm aperture. By keeping the volume average particle size within the aforementioned range, it is possible to attain a high-quality image that exhibits excellent dot reproducibility and is free from fogging and toner scattering. If the volume average particle size is less than 4 μm, there arises lack of flowability and easiness in handling. If the volume average particle size is greater than 7 μm, there arises deterioration in dot reproducibility. It will thus be preferable that the toner particles range in volume average particle size from 4 to 7 μm.

The toner thus produced may be mixed with an external additive capable of serving powder fluidity enhancement, frictional chargeability enhancement, provision of heat resistance, long-time storage stability improvement, cleaning characteristic improvement, photoreceptor-surface abrasion property control, and so forth.

Fine inorganic particles having an average particle size of 7 to 200 nm, such as silica, titanium oxide, alumina, or the like, can be used as the external additive. It is preferable that, for the purpose of imparting hydrophobicity, such fine inorganic particles are subjected to a surface treatment using a silane coupling agent, a titanium coupling agent, and a silicone oil. This is because the hydrophobic fine inorganic particles are less prone to reduction in electric resistance and in charging amount under a high-humidity condition. It is preferable that the external additive is added in an amount ranging from 0.2% to 3% and below by weight. If the amount of addition of the external additive is less than 0.2% by weight, it becomes difficult to provide the effect of fluidity enhancement. By contrast, if the amount of addition of the external additive is greater than 3% by weight, the fixability will be decreased. Moreover, as to how the external additive is to be added, in general, it is mixed with the toner particles by an airflow mixer such as Henschel Mixer.

In the aforestated manner, the toner is externally added with the external additive on an as needed basis, and such a toner can be used in an as-is state as a one-component developer, or can be used as a two-component developer in admixture with a carrier. When used as a one-component developer, the toner is used alone without having to use a carrier. Moreover, when used as a one-component developer, the toner is electrically charged by friction on a developing sleeve with use of a blade and a fur brush, so that it can be adhered onto the sleeve. In this way, the toner becomes conveyable so as to effect image formation.

On the other hand, when used as a two-component developer, the toner is used in conjunction with a carrier. As the carrier, magnetic particle having a volume average particle size of 20 to 45 μm can be used. If the volume average particle size of the carrier is less than 20 μm, due to the movement of the carrier from a developing roller to the photoreceptor drum 51 in the course of development, the image obtained could suffer from a white spot. By contrast, if the volume average particle size of the carrier is greater than 45 μm, the dot reproducibility becomes so poor that the image obtained appears grainy. Note that the volume average particle size of the carrier takes on a value which is obtained by measurement under a condition where a dispersive pressure of 3.0 bar is applied with use of Particle Size Distribution Analyzer with Laser Diffraction HELOS (manufactured by SYMPATEC GmbH) in conjunction with Dry Dispersing Unit RODOS (manufactured by SYMPATEC GmbH).

As to saturated magnetization of a carrier, magnetic brush (which is formed on the surface of the developing roller)in contact with the photoreceptor drum 51 is softer with lower saturated magnetization. When the magnetic brush is soft, images can be authentically reproduced from electrostatic latent images. However, too low saturated magnetization may cause the carrier to be attached to the surface of the photoreceptor drum 51 and thus easily generate white spots, while too high saturated magnetization results in rigid magnetic brush that impedes authentic image reproduction of electrostatic latent images. As a result, the saturated magnetization of the carrier falling in a range of from 30 emu/g to 100 emu/g is preferably used.

As such a carrier, there has been widely used a coated-type carrier formed by applying a coating layer onto the surface of core particles that possess magnetic properties. While heretofore known magnetic particles can be used as the core particles, ferrite-based particles are desirable for use. This is because, since the ferrite-based particles lend themselves to formation of a carrier of high saturation magnetization, its use makes it possible to reduce the amount of carrier adherent to the photoreceptor drum 51. As the ferrite-based particles, heretofore known ones can be used. The examples thereof include zinc-based ferrite, nickel-based ferrite, copper-based ferrite, nickel and zinc-based ferrite, manganese and magnesium-based ferrite, copper and magnesium-based ferrite, manganese and zinc-based ferrite, and manganese, copper, and zinc-based ferrite.

Those ferrite-based particles can be formed by heretofore known methods. For example, ferrite raw materials such as Fe₂O₃ and Mg (OH)₂ are mixed together, and the resultant admixture powder is subjected to calcination under application of heat in a heating furnace. The resultant calcined product is cooled down, and is whereafter pulverized by a vibrational mill into ca. 1 μm-size particles. The pulverized powder is added with a dispersant and water to prepare a slurry. The slurry is wet-milled by a wet ball mill, and the resultant suspension liquid is dry-granulated by a spray drier. In this way, there are obtained ferrite particles.

As a coating material for forming the coating layer, it is possible to use heretofore known resin materials such for example as an acrylic resin and a silicone resin. In particular, a coated-type carrier coated with a straight silicone resin (alkyl substituted silicone resin) is desirable, because its use is effective in retarding development of chipping at the edge portion of a cleaning blade.

For silicone resin, the known ingredients can be used including, for example: silicone varnish such as TSR115, TSR114, TSR102, TSR103, YR3061, TSR110, TSR116, TSR 117, TSR108, TSR109, TSR180, TSR181, TSR187, TSR144, and TSR165 manufactured by TOSHIBA Corporation., and KR271, KR272, KR275, KR280, KR282, KR267, KR269, KR211, and KR212 manufactured by Shin-Etsu Chemical Co., Ltd.; alkyd-modified silicone varnish such as TSR184 and TSR185, manufactured by TOSHIBA Corporation.; epoxy-modified silicone varnish such as TSR194 and YS54, manufactured by TOSHIBA Corporation.; polyester-modified silicone varnish such as TSR 187 manufactured by TOSHIBA Corporation.; acryl-modified silicone varnish such as TSR170 and TSR171 manufactured by TOSHIBA Corporation.; urethane-modified silicone varnish such as TSR175 manufactured by TOSHIBA Corporation.; and reactive silicone resin such as KA1008, KBE1003, KBC1003, KBM303, KBM403, KBM503, KBM602, and KBM603 manufactured by Shin-Etsu Chemical Co., Ltd.

To the coating material, a conductive agent is added for adjusting the volume resistivity of the carrier. Examples of the conductive agent include silicon oxide, alumina, carbon black, graphite, zinc oxide, titanium black, iron oxide, titanium oxide, tin oxide, potassium titanate, calcium titanate, aluminum borate, magnesium oxide, barium sulfate, and calcium carbonate.

Among these conductive agent, carbon black is preferred in terms of production stability, low cost, low electric resistance, etc. A kind of carbon black is not particularly limited, and carbon black having DEP (dibutyl phthalate) oil absorption of 90 ml/100 g to 170 ml/100 g is preferred owing to its excellent production stability. Moreover, carbon black having a primary particle size of 100 nm or less is particularly preferred owing to its excellent dispersibility. The conductive agent may be used each alone, or two or more of the conductive agents may be used in combination. An amount of the conductive agent for using is 0.1 part by weight to 20 parts by weight based on 100 parts by weight of the resin material.

The carrier particles can be coated with the coating material by heretofore known methods. The examples thereof include: an immersion method for soaking the carrier particles in an organic solvent solution of the coating material; a spray method for spraying an organic solvent solution of the coating material onto the carrier particles; a fluid bed method for spraying an organic solvent solution of the coating material onto the carrier particles in a state of being floated by flowing air; and a kneader coater method involving a step of mixing the carrier particles and an organic solvent solution of the coating material in a kneader coater and a step of removing the solvent medium. At this time, in addition to the coating material, a conductive material for resistance value control is added to the organic solvent solution of the coating material.

The transfer roller 55 is disposed face to face with the photoreceptor drum 51 while being supported so as to be driven to rotate about its axis by a non-illustrated driving portion. On the transfer roller 55 is impressed a bias voltage of a polarity reverse to the polarity of the toner. Upon this bias voltage being supplied to a recording paper sheet, the toner image formed on the photoreceptor drum 51 through development effected by the developing unit 54 is transferred onto the recording paper sheet.

The cleaning device 56 includes a cleaning blade and a cleaner housing that are not shown. The cleaning blade is so disposed that its edge portion can be brought into pressure-contact with the surface of the photoreceptor drum 51 in a direction reverse to the rotation direction of the photoreceptor drum 51. In this way, the edge portion of the cleaning blade serves to scrape off residual matters remaining on the surface of the photoreceptor drum 51. The cleaner housing stores therein the scraped residual matters.

The paper conveying section 30, which includes a plurality of conveying rollers, conveys a recording paper sheet from the paper feeding unit 20 toward the paper output tray 31. At this time, the recording paper sheet being conveyed by the paper conveying section 30 is subjected to a toner image formation process in the image forming unit 50 and is whereafter directed to the fixing device 40 embodying the invention.

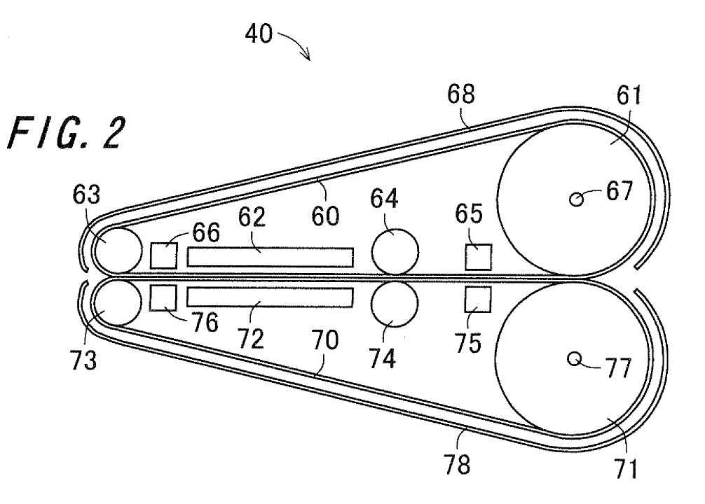

FIG. 2 is a view showing the structure of the fixing device 40 in accordance with a first embodiment of the invention. The fixing device 40 serves to fix a toner image formed on a recording paper sheet onto the recording paper sheet by bringing about toner-image fusion. The toner image is constituted by the aforestated toner containing the binder resin composed of crystalline polyester and amorphous polyester and the release agent having a melting point lower than the melting point of the crystalline polyester.

The fixing device 40 includes a first fixing belt 60 and a second fixing belt 70 that are arranged face to face with each other and are driven to turn in opposite directions. By the fixing device 40, a yet-to-be-fixed toner image formed on a recording paper sheet passing through a region between the first fixing belt 60 and the second fixing belt. 70 is fused, so that the toner image can be fixed onto the recording paper sheet in the fixing device 40, out of the two fixing belts arranged face to face with each other, the first fixing belt 60 has its surface contacted by one of the surfaces of the recording paper sheet having a yet-to-be-fixed toner image formed thereon. In a case where an image is formed on both surfaces of the recording paper sheet, at first, a yet-to-be-fixed toner image borne on one of the surfaces of the recording paper sheet,is brought into contact with the surface of the first fixing belt 60 so as to undergo fixation. After that, the recording paper sheet is turned over manually or by means of a reversing mechanism or otherwise, so that a yet-to-be-fixed toner image borne on the other surface of the recording paper sheet can be brought into contact with the surface of the first fixing belt 60 so as to undergo fixation. That is, before the yet-to-be-fixed toner image borne on the other surface of the recording paper sheet is subjected to fixation, the one surface of the recording paper sheet has already a fixed toner image, and the one surface is brought into contact with the surface of the second fixing belt 70. The first fixing belt 60 is an endless belt member supported around a plurality of support rollers, namely a first heating roller 61 and a first pulling roller 63, with tension. The first fixing belt 60 is driven to turn in accompaniment with the rotation of the first heating roller 61. The second fixing belt 70 is similar in structure to the first fixing belt 60, and more specifically it is an endless belt member which is supported around a second heating roller 71 and a second pulling roller 73 with tension and is driven to turn in accompaniment with the rotation of the second heating roller 71. The second fixing belt 70 is so disposed as to extend in a direction in which the first fixing belt 60 extends (turning direction of the first fixing belt 60) face to face with the first fixing belt 60.

The first fixing belt 60 and the second fixing belt 70 are each constructed by forming, on the outer side of a 1 mm-thick base layer made of heat-resistant polyimide, a ca. 30 μm-thick releasing layer made of a PFA (copolymer tetrafluoroethylene and perfluoroalkyl vinylether) tube. Note that, other than PFA, any given material can be used for the releasing layer so long as it is excellent in heat resistance and durability, and exhibits good releasability with respect to the toner. For example, fluorine-based materials such as PTFE (polytetrafluoroethylene) can be adopted for use.

The first heating roller 61 and the second heating roller 71 are each disposed in a rotatable manner and rotatably driven by a driving motor acting as a non-illustrated driving portion. As the first heating roller 61 and the second heating roller 71 are rotated, the first fixing belt 60 and the second fixing belt 70 are each allowed to turn. The first heating roller 61 and the second heating roller 71, which are each constructed of a cylindrically shaped drum made of aluminum, are arranged on the most upstream side with respect to the turning direction of the first fixing belt 60 and on the most upstream side with respect to the turning direction of the second fixing belt 70, respectively.

Within the first heating roller 61 is disposed a first heater lamp 67 acting as the heating portion, which is constructed of a halogen lamp for effecting heat radiation. Moreover, within the second heating roller 71 is disposed a second heater lamp 77 acting as the heating portion, which is constructed of a halogen lamp for effecting heat radiation. By arranging the first heater lamp 67 and the second heater lamp 77 acting as the heating portions within the first heating roller 61 and the second heating roller 71, respectively, it is possible to accumulate heat energy produced by the heating portions in the heating rollers interiorly thereof. Accordingly, upon a restart of the operation of the fixing device 40 after a halt, the temperature of a region of each of the first fixing belt 60 and the second fixing belt 70 close to the heating portion can be adjusted to become a predetermined temperature at once. Note that, while, in the present embodiment, the first heater lamp 67 and the second heater lamp 77 are each constructed of a single halogen lamp, the invention is not limited thereto. For example, in order to gain an optimal temperature distribution in conformity with recording paper size, the heater lamp can include a plurality of halogen lamps for axially divided heat generation distributions.

The first heater lamp 67 is controlled by a temperature control unit 90 which will hereafter be described. The first heater lamp 67 applies heat to the first fixing belt 60, which is contacted by the yet-to-be-fixed toner image-bearing surface of the recording paper sheet, from the inside so that the temperature of a region of the first fixing belt 60 in contact with the first heating roller 61; that is, the temperature of the close-to-heating portion region thereof can be adjusted to become a predetermined temperature (fixing temperature) higher than or equal to the melting point of the crystalline polyester, and more specifically a temperature selected in a range of from 130 to 200° C.

The second heater lamp 77 is controlled by the subsequently-described temperature control unit 90, and applies heat to the second fixing belt 70, which is contacted by the fixed toner image-bearing surface or the toner image-free surface) of the recording paper sheet, from the inside so that the temperature of a region of the second fixing belt 70 in contact with the second heating roller 71; that is, the temperature of the close-to-heating portion region thereof can be adjusted to become a predetermined temperature higher than or equal to the melting point of the crystalline polyester. It is preferable that the temperature of the close-to-heating portion region of the second fixing belt 70 under application of heat by the second heater lamp 77 is lower by 20 to 50° C. than the fixing temperature set for the first fixing belt 60.

Moreover, in the state where the first fixing belt 60 and the second fixing belt 70 are arranged face to face with each other, the first heating roller 61 and the second heating roller 71 are kept in pressure-contact with each other, with the first fixing belt 60 and the second fixing belt 70 interposed therebetween, under a predetermined load (400 N, for instance) exerted by an elastic member (not shown) formed of a spring member. In this way, a pressure is produced between the first fixing belt 60 and the second fixing belt 70, thus expediting heat fusion of the toner image.

The first pulling roller 63 and the second pulling roller 73 are arranged face to face with each other, with the first fixing belt 60 and the second fixing belt 70 interposed therebetween. The first pulling roller 63 and the second pulling roller 73 are each provided with an elastic member (not shown) formed of a spring member, and are spaced horizontally away from the first heating roller 61 and the second heating roller 71, respectively, under a predetermined load (100 N, for instance). In this way, the first fixing belt 60 and the second fixing belt 70 can be prevented from sagging down, thus achieving smooth. conveyance of the recoding paper sheet.

Moreover, in the fixing device 40 of the invention, inside the first fixing belt 60 is disposed a first cooling portion 62 formed of a Peltier element so as to be located downstream from the first heating roller 61 with respect to the turning direction of the first fixing belt 60. At this time, the first cooling portion 62 is so disposed that the heat absorbing surface of the Peltier element is opposed vicinally to the inner surface of that part of the first fixing belt 60 which faces the second fixing belt 70, and that the heat generating surface of the Peltier element is opposed to the inner surface of the part of the first fixing belt 60 opposite from the second fixing belt 70-facing side thereof. Thereby, the first cooling portion 62, while cools down the inner surface of the second fixing belt 70-facing side of the first fixing belt 60 by exploiting the endothermic effect of the Peltier element's heat absorbing surface, heats the inner surface of the part of the first fixing belt 60 opposite from the second fixing belt 70-facing side thereof by exploiting the exothermic effect of the Peltier element's heat generating surface (the effect of producing heat with exothermic energy corresponding to cooling energy generated at the Peltier element's heat absorbing surface).

That is, as the first fixing belt 60 is driven to turn, its surface is heated by the first heating roller 61, is cooled down by the endothermic effect of the Peltier element's heat absorbing surface of the first cooling portion 62 disposed on the downstream side with respect to the turning direction, and is again heated by the exothermic effect of the Peltier element's heat generating surface of the first cooling portion 62. In this way, the exothermic energy generated at the Peltier element's heat generating surface corresponding to the cooling energy generated at the Peltier element's heat absorbing surface can be effectively utilized as heat energy for heating the first fixing belt 60. This leads to a reduction in energy consumption.

In addition, inside the second fixing belt 70 is disposed a second cooling portion 72 formed of a Peltier element so as to be located downstream from the second heating roller 71 with respect to the turning direction of the second fixing belt 70. At this time, the second cooling portion 72 is so disposed that the heat absorbing surface of the Peltier element is opposed vicinally to the inner surface of that part of the second fixing belt 70 which faces the first fixing belt 60, and that the heat generating surface of the Peltier element is opposed the inner surface of the part of the second fixing belt 70 opposite from the first fixing belt 60-facing side thereof. Thereby, the second cooling portion 72, while cools down the inner surface of the first fixing belt 60-facing side of the second fixing belt 70 by exploiting the endothermic effect of the Peltier element's heat absorbing surface, heats the inner surface of the part of the second fixing belt 70 opposite from the first fixing belt 60-facing side thereof by exploiting the exothermic effect of the Peltier element's heat generating surface.

That is, as the second fixing belt 70 is driven to turn, its surface is heated by the second heating roller 71, is cooled down by he endothermic effect of the Peltier element's heat absorbing surface of the second cooling portion 72 disposed on the downstream side with respect to the turning direction, and is again heated by the exothermic effect of the Peltier element's heat generating surface of the second cooling portion 72. In this way, the exothermic energy generated at the Peltier element's heat generating surface corresponding to the cooling energy generated at the Peltier element's heat absorbing surface can be effectively utilized as heat energy for heating the second fixing belt 70. This leads to a reduction in energy consumption.

In this construction, the first cooling portion 62 is located downstream from the first heating roller 61 with respect to the turning direction of the first fixing belt 60 and in the vicinity of the first pulling roller 63 disposed on the most downstream side with respect to the turning direction, for supporting the first fixing belt 60 therearound with tension. Moreover, the second cooling portion 72 is located downstream from the second heating roller 71 with respect to the turning direction of the second fixing belt 70 and in the vicinity of the second pulling roller 73 disposed on the most downstream side with respect to the turning direction, for supporting the second fixing belt 70 therearound with tension.

The outer diameters of the first heating roller 61 and the second heating roller 71, and the outer diameters of the first pulling roller 63 and the second pulling roller 73 are so determined that the inner surfaces of the first fixing belt 60 and the second fixing belt 70 can be heated by the exothermic effect of the Peltier element's heat generating surface of the first cooling portion 62 and the exothermic effect of the Peltier element's heat generating surface of the second cooling portion 72, respectively, with a loss of energy minimized. That is, the first pulling roller 63 is so designed that its outer diameter constitutes a predetermined percent of the outer diameter of the first heating roller 61, and similarly the second pulling roller 73 is so designed that its outer diameter constitutes a predetermined percent of the outer diameter of the second heating roller 71. By setting the outer diameter of the pulling roller to be smaller than the outer diameter of the heating roller in that way, it is possible to position the inner surfaces of the first fixing belt 60 and the second fixing belt 70 in the proximity of the Peltier element's heat generating surface of the first cooling portion 62 and that of the second cooling portion 72, respectively. To be more specific, the outer diameters of the first pulling roller 63 and the second pulling roller 73 may be so adjusted to constitute 20 to 80 percent of the outer diameters of the first heating roller 61 and the second heating roller 71, respectively.

Moreover, the heat energy generated at the Peltier element's heat generating surface of each of the first cooling portion 62 and the second cooling portion 72 can be converted into electric energy. In this case, this electric energy is supplied to the first heater lamp 67 and the second heater lamp 77.

In the first fixing belt 60 which is cooled down by the first cooling portion 62 under the control of the subsequently-described temperature control unit 90, the temperature of that part thereof close to the first cooling portion 62, or in other words, the close-to-cooling portion region thereof is adjusted to become a predetermined temperature which is higher than or equal to the melting point of the release agent contained in the toner constituting the toner image but lower than the melting point of the crystalline polyester. With consideration given to the difference in temperature between the first fixing belt 60 and the toner in contact therewith; that is, the heat transfer rate, the temperature of the close-to-cooling portion region of the first fixing belt 60 should preferably be higher than or equal to the melting point of the release agent contained in the toner but lower by 15° C. than the melting point of the crystalline polyester.

Moreover, in the second fixing belt 70 which is cooled down by the second cooling portion 72 under the control of the subsequently-described temperature control unit 90, the temperature of that part thereof close to the second cooling portion 72, or in other words, the close-to-cooling portion region thereof is adjusted to become a predetermined temperature which is higher than or equal to the melting point of the release agent contained in the toner constituting the toner image but lower than the melting point of the crystalline polyester.

Moreover, the fixing device 40 includes a first heating-side temperature detecting portion 65 and a second heating-side temperature detecting portion 75 that are each constructed of a thermistor. The first heating-side temperature detecting portion 65 is disposed in contact with the midportion of the first fixing belt 60 in its widthwise direction (a direction perpendicular to the turning direction), for detecting the temperature of that part of the first fixing belt 60 which is located downstream from the first heating roller 61 and upstream from the first cooling portion 62 with respect to the turning direction of the first fixing belt 60. The second heating-side temperature detecting portion 75 is disposed in contact with the midportion of the second fixing belt 70 in its widthwise direction (a direction perpendicular to the turning direction), for detecting the temperature of that part of the second fixing be it 70 which is located downstream from the second heating roller 71 and upstream from the second cooling portion 72 with respect to the turning direction of the second fixing belt 70. Note that the placement position of the first heating-side temperature detecting portion 65 in the widthwise direction of the first fixing belt 60, as well as the placement position of the second heating-side temperature detecting portion 75 in the widthwise direction of the second fixing belt 70, is not limited to the midportion as described just above. For example, the first heating-side temperature detecting portion 65 and the second heating-side temperature detecting portion 75 can be placed at the widthwise end of the first fixing belt 60 and the widthwise end of the second fixing belt 70, respectively. In a case where the widthwise midportion and the widthwise end of the fixing belt differ from each other in the amount of heat applied thereto by the first heater lamp 67 as well as the second heater lamp 77, it is possible to arrange a plurality of temperature detecting portions along the widthwise direction.

Moreover, the fixing device 40 includes a first cooling-side temperature detecting portion 66 and a second cooling-side temperature detecting portion 76 that are each constructed of a thermistor. The first cooling-side temperature detecting portion 66 detects the temperature of that part of the first fixing belt 60 which is located downstream from the first cooling portion 62 and upstream from the first pulling roller 63 with respect to the turning direction of the first fixing belt 60. The second cooling-side temperature detecting portion 76 detects the temperature of that part of the second fixing belt 70 which is located downstream from the second cooling portion 72 and upstream from the second pulling roller 73 with respect to the turning direction of the second fixing belt 70.

Further, it is preferable that, in the fixing device 40, there is disposed a pair of pressure rollers 64 and 74 that are brought into pressure-contact with each other, with the first fixing belt 60 and the second fixing belt 70 interposed therebetween, for constituting a fixing nip region. The pressure roller 64 is located between the first heating roller 61 and the first cooling portion 62 in the turning direction of the first fixing belt 60, and the pressure roller 74 is located between the second heating roller 71 and the second cooling portion 72 in the turning direction of the second fixing belt 70. With this arrangement, it is possible to achieve tight mutual adhesion among the toner portions constituting the yet-to-be-fixed toner image, now in a fused state through application of heat by the first heater lamp 67, borne on the recording paper sheet passing through the region between the first fixing belt 60 and the second fixing belt 70 by exploiting a force developed by the pressure contact of the paired pressure rollers 64 and 74. Accordingly, the strength of fixation of the toner image on the recording paper sheet can be increased. The paired pressure rollers 64 and 74 each have a ca. 3 mm-thick heat-resistant elastic layer made of silicone rubber whose JIS-A hardness is approximately 20 degrees, formed on the surfaces thereof and are kept in pressure-contact with each other under a predetermined load (500 N, for instance) exerted by an elastic member (not shown) formed of a spring member.

In addition, it is preferable that the fixing device 40 includes a first heat insulating member 68 and a second heat insulating member 78 that are each formed of a heat insulator material. The first heat insulating member 68 extends in the extending direction of the first fixing belt 60, for covering a region of the first fixing belt 60 other than that region thereof which faces the second fixing belt 70 from its outside. The second heat insulating member 78 extends in the extending direction of the second fixing belt 70, for covering a region of the second fixing belt 70 other than that region thereof which faces the first fixing belt 60 from its outside. In this case, the first heat insulating member 68 serves to prevent the heat given off by the first fixing belt 60 heated by the first heater lamp 67 from escaping out of the fixing device 40, and the second heat insulating member 78 serves to prevent the heat given off by the second fixing belt 70 heated by the second heater lamp 77 from escaping out of the fixing device 40. Accordingly, upon a restart of the operation of the fixing device 40 after a halt, the temperature of the close-to-heating portion region of each of the first fixing belt 60 and the second fixing belt 70 can be adjusted to become the predetermined temperature at once. As the materials of construction of the first heat insulating member 68 and the second heat insulating member 78, heat insulator materials having resistance to heat of 200° C. or above are desirable for use. For example, it is possible to use a platy body formed by inserting ceramic fiber, glass wool, or the like material into polyimide resin.

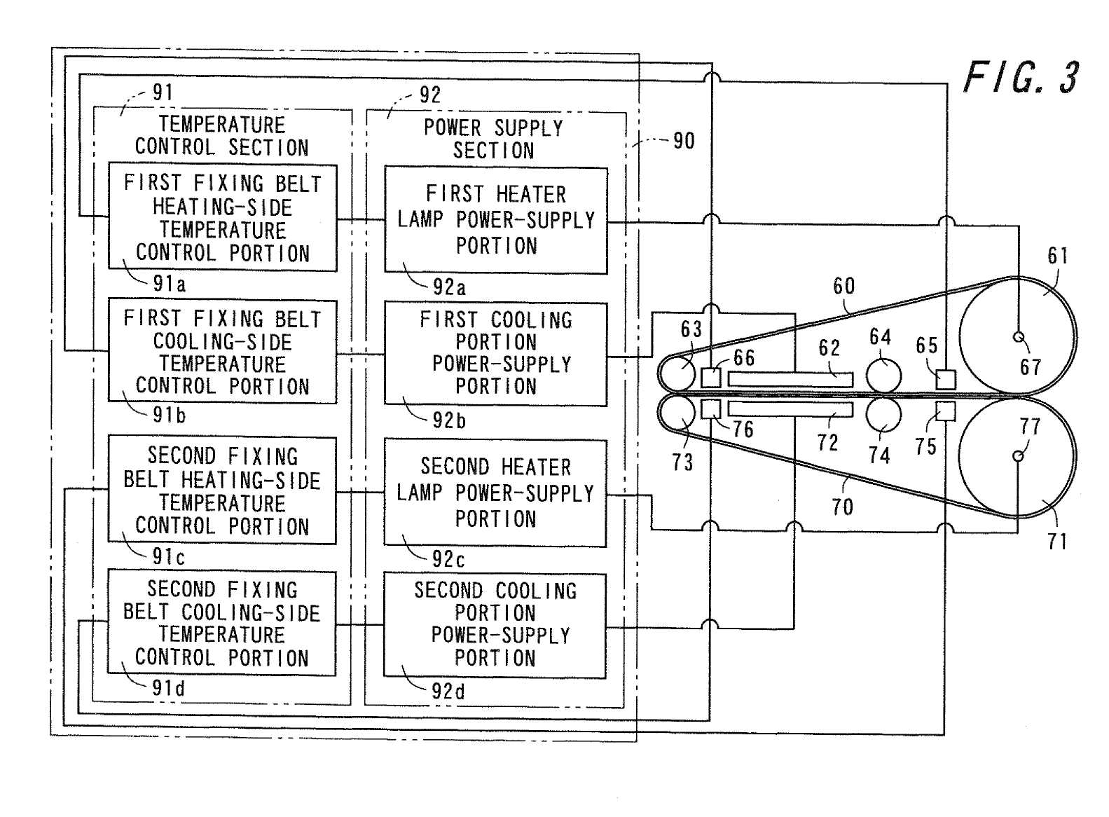

FIG. 3 is a view showing the configuration of the temperature control unit 90 of the fixing device 40. The temperature control unit 90 disposed in the fixing device 40 includes a temperature control section 91 constructed of a control integrated circuit board and a power supply section 92. On the basis of the results of detection provided from the first heating-side temperature detecting portion 65 and the first cooling-side temperature detecting portion 66, the temperature control unit 90 effects control of the first heater lamp 67 and the first cooling portion 62 in a manner so as to adjust each of the temperature of the close-to-heating portion region of the first fixing belt 60 and the temperature of the close-to-cooling portion region thereof to become the predetermined temperature. Moreover, on the basis of the results of detection provided from the second heating-side temperature detecting portion 75 and the second cooling-side temperature detecting portion 76, the temperature control unit 90 effects control of the second heater lamp 77 and the second cooling portion 72 in a manner so as to adjust each of the temperature of the close-to-heating portion region of the second fixing belt 70 and the temperature of the close-to-cooling portion region thereof to become the predetermined temperature.

The temperature control section 91 of the temperature control unit 90 includes a first fixing belt heating-side temperature control portion 91a, a first fixing belt cooling-side temperature control portion 91b, a second fixing belt heating-side temperature control portion 91c, and a second fixing belt cooling-side temperature control portion 91d that are connected to the first heating-side temperature detecting portion 65, the first cooling-side temperature detecting portion 66, the second heating-side temperature detecting portion 75, and the second cooling-side temperature detecting portion 76, respectively. The temperature data obtained by detection in each of the temperature detecting portions is sent to the temperature control section 91.

The power supply section 92 of the temperature control unit 90 includes a first heater lamp power-supply portion 92a, a first cooling portion power-supply portion 92b, a second heater lamp power-supply portion 92c, and a second cooling portion power-supply portion 92d that are connected to the first fixing belt heating-side temperature control portion 91a, the first fixing belt cooling-side temperature control portion 91b, the second fixing belt heating-side temperature control portion 91c, and the second fixing belt cooling-side temperature control portion 91d, respectively. The first heater lamp power-supply portion 92a, the first cooling portion power-supply portion 92b, the second heater lamp power-supply portion 92c, and the second cooling portion power-supply portion 92d are connected also to the first heater lamp 67, the first cooling portion 62, the second heater lamp 77, and the second cooling portion 72, respectively. On the basis of the signals issued from the temperature control section 91, the power-supply portions effect the supply of power individually to adjust the temperature of each of the first fixing belt 60 and the second fixing belt 70 to become the predetermined temperature.

Next, the workings of the fixing device 40 will be described below. According to the fixing device 40, the first fixing belt 60 and the second fixing belt 70 in a turnably driven state convey, in sandwich style, a recording paper sheet supplied to the fixing nip region created between the first fixing belt 60 and the second fixing belt 70 after being transported from the image forming unit 50 at a predetermined fixing rate (175 mm/sec, for instance).

At this time, the first heater lamp 67 and the second heater lamp 77 are controlled by the temperature control unit 90 so that the temperature of that part of the first fixing belt 60 which is located on the most upstream side with respect to its turning direction; that is, the close-to-heating portion region of the first fixing belt 60, as well as the temperature of that part of the second fixing belt 70 which is located on the most upstream side with respect to its turning direction; that is, the close-to-heating portion region of the second fixing belt 70, can be heated to the predetermined temperature higher than or equal to the melting point of the crystalline polyester. In this way, a yet-to-be-fixed toner image borne on the recording paper sheet can be fused. Thus, since the first heater lamp 67 applies heat to the first fixing belt 60, whereas the second heater lamp 77 applies heat to the second fixing belt 70, it follows that the yet-to-be-fixed toner image borne on the recording paper sheet passing through the region between the first fixing belt 60 and the second fixing belt 70 can be fused sufficiently without having to apply unduly high heat to one of the fixing belts.

Moreover, the paired pressure rollers 64 and 74 kept in pressure-contact with each other, with the first fixing belt 60 and the second fixing belt 70 interposed therebetween, serve to achieve tight mutual adhesion among the toner portions constituting the toner image borne in a fused state on the recording paper sheet by exploiting the pressure contact force. This helps increase the strength of fixation of the toner image on the recording paper sheet.

Further, under the control of the temperature control unit 90, the first cooling portion 62 located downstream from the pressure roller 64 with respect to the turning direction of the first fixing belt 60 provides cooling for the close-to-cooling portion region of the first fixing belt 60 so that its temperature can be adjusted to become the predetermined temperature which is higher than or equal to the melting point of the release agent contained in the toner constituting the toner image but lower than the melting point of the crystalline polyester. Similarly, under the control of the temperature control unit 90, the second cooling portion 72 located downstream from the pressure roller 74 with respect to the turning direction of the second fixing belt 70 provides cooling for the close-to-cooling portion region of the second fixing belt 70 so that its temperature can be adjusted to become the predetermined temperature which is higher than or equal to the melting point of the release agent contained in the toner constituting the toner image but lower than the melting point of the crystalline polyester. This makes it possible to solidify the toner constituting the toner image, now in a fused state through application of heat by the first heater lamp 67 and the second heater lamp 77, borne on the recording paper sheet, and thereby prevent occurrence of a hot-offset phenomenon and smudges caused by the fixing operation. At this time, since the temperature of the close-to-cooling portion region of the first fixing belt 60 cooled by the first cooling portion 62, as well as the temperature of the close-to-cooling portion region of the second fixing belt 70 cooled by the second cooling portion 72, is higher than or equal to the melting point of the release agent contained in the toner constituting the toner image, it is possible to impart releasability to the toner constituting the toner image. Accordingly, the toner image can be prevented from adhering to the first fixing belt 60, in consequence whereof there results no hot-offset phenomenon.

In the manner thus far described, the recording paper sheet undergoes the toner-image fixing operation in the fixing device 40, and is whereafter passed through the inter-roller region between the first pulling roller 63 and the second pulling roller 73 disposed on the most downstream side in the turning direction of the first fixing belt 60 and the most downstream side in the turning direction of the second fixing belt 70, respectively, so as to be eventually ejected into the paper output tray 31 of the image forming apparatus 1.

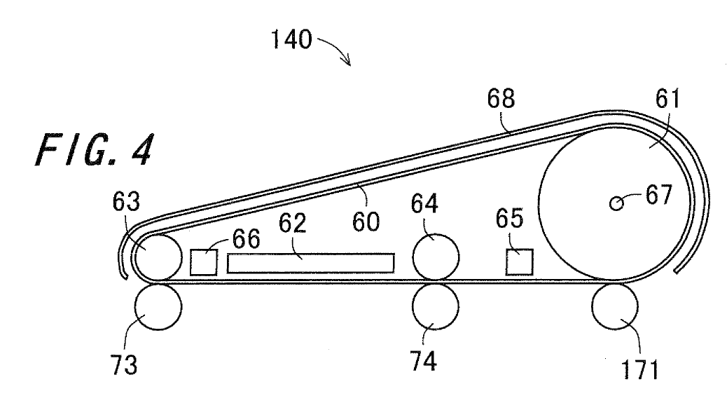

FIG. 4 is a view showing the structure of a fixing device 140 in accordance with a second embodiment of the invention. The fixing device 140 of the second embodiment is analogous to the fixing device 40 described hereinabove, and thus its constituent components that play the same or corresponding roles as in the fixing device 40 will be identified with the same reference symbols and overlapping descriptions will be omitted. The fixing device 140 includes a first fixing belt 60 which is similar in construction to the first fixing belt of the fixing device 40 described hereinabove, and a fixing roller 171 which is so disposed as to be pressure-contactable with a first heating roller 61, with the first fixing belt 60 interposed therebetween. The first heating roller 61 is a support roller disposed on the most upstream side with respect to the turning direction of the first fixing belt 60. By the fixing device 140, a yet-to-be-fixed toner image formed on a recording paper sheet passing through a region between the first fixing belt 60 and the fixing roller 171 is fused, so that the toner image can be fixed onto the recording paper sheet. In the fixing device 140, as has already been described, with the provision of the fixing roller 171 instead of the second fixing belt 70, the yet-to-be-fixed toner image formed on the recording paper sheet passing through the region between the first fixing belt 60 and the fixing roller 171 is fused, so that the toner image can be fixed onto the recording paper sheet. Otherwise, the fixing device 140 has the same structure as that of the fixing device 40.

In the fixing device 140, an the basis of the results of detection produced by the first heating-side temperature detecting portion 65 and the first cooling-side temperature detecting portion 66, the temperature control unit 90 effects control of the first heater lamp 67, the first cooling portion 62, and the second cooling portion 72 in a manner so as to adjust each of the temperature of the close-to-heating portion region of the first fixing belt 60 and the temperature of the close-to-cooling portion region thereof to become a predetermined temperature.

In the fixing device 140, under the control of the temperature control unit 90, the first heater lamp 67 applies heat so that the temperature of that part of the first fixing belt 60 which is located on the most upstream side with respect to its turning direction; that is, the temperature of the close-to-heating portion region of the first fixing belt 60 can be adjusted to become the predetermined temperature which is higher than or equal to the melting point of the crystalline polyester. In this way, the yet-to-be-fixed toner image borne on the recording paper sheet can be fused. Moreover, the paired pressure rollers 64 and 74 that are brought into pressure-contact with each other, with the first fixing belt 60 interposed therebetween, serve to achieve tight mutual adhesion among the toner portions constituting the toner image borne in a fused state on the recording paper sheet by exploiting the pressure contact force. Further, under the control of the temperature control unit 90, the first cooling portion 62 and the second cooling portion 72 located downstream from the pressure roller 64 and the pressure roller 74, respectively, with respect to the turning direction of the first fixing belt 60 provide cooling for the close-to-cooling portion region of the first fixing belt 60 so that its temperature can be adjusted to become the predetermined temperature which is higher than or equal to the melting point of the release agent contained in the toner constituting the toner image but lower than the melting point of the crystalline polyester. This makes it possible to solidify the toner constituting the toner image, now in a fused state through application of heat by the first heater lamp 67, borne on the recording paper sheet, and thereby prevent occurrence of a hot-offset phenomenon and smudges caused by the fixing operation. At this time, since the temperature of the close-to-cooling portion region of the first fixing belt 60 cooled by the first cooling portion 62 and the second cooling portion 72 is higher than or equal to the melting point of the release agent contained in the toner constituting the toner image, it is possible to impart releasability to the toner constituting the toner image. Accordingly, the toner image can be prevented from adhering to the first fixing belt 60, in consequence whereof there results no hot-offset phenomenon.

### Examples

Hereinafter, the invention will be described in more detail with the implementation of Examples and Comparative examples.

<Methods for Measuring Physical Property Values>

Various physical property values as to the toner and the resin constituting the toner have been measured as follows.

[Acid Value of Resin]

The acid value of the polyester resin constituting the toner was measured in accordance to the method prescribed in JIS K 0070. At that time, in a case where an ethyl acetate insoluble component is contained in an amount of 3.0% or above by weight, dioxane was used as a solvent for acid value measurement.

[Softening Point of Resin}

With use of Flow Tester (trade name: CFT-100C manufactured by Shimadzu Corporation), a load of 10 kgf/cm² (0.98 MPa) has been applied to extrude a test sample of 1 g from a die (1.0 mm in nozzle bore diameter and 1.0 mm in length) while applying heat at a temperature elevation rate of 6° C. per minute. Then, a temperature at which half of the test sample was flowed out of the die (½ flowed-out temperature) was obtained as the softening point.

[Glass Transition Temperature of Resin]

With use of a differential scanning calorimeter (trade name: DSC 220 manufactured by Seiko Instruments & Electronics Ltd.) and in conformity with Japan industrial Standards (JIS) K 7121-1987, a test sample of 1 g has been heated at a temperature elevation rate of 10° C. per minute to measure a DSC curve. On the basis of the DSC curve obtained, as the glass transition temperature (Tg), there was obtained a temperature at the point of intersection between the base line extending straightly from the high temperature side to the low temperature side with respect to the endothermic peak corresponding to glass transition and the tangential line drawn at a point where the gradient of the curve from the starting part of the peak to the vertex of the peak is at the maximum.

[Melting Point of Resin (Highest Temperature of Endothermic Peak)]

With use of a differential scanning calorimeter (trade name: DSC 220 manufactured by Seiko Instruments & Electronics Ltd.), a test sample of 1 g has been heated at a temperature elevation rate of 10° C. per minute to measure a DSC curve. On the basis of the DSC curve obtained, as the melting point, there was obtained a peaked temperature at the highest temperature side of the endothermic peak of the DSC curve; that is, the highest temperature of endothermic peak.

[Crystallinity Index of Resin]

With use of the softening point and the highest temperature of endothermic peak obtained by measurement in the forestated way, the degree of crystallinity was calculated from the following formula to derive an index of crystallinity.

Crystallinity index=(Softening point)/(Highest temperature of endothermic peak)

[Volume Average Particle Size of Toner]

20 mg of the toner and 1 ml of sodium alkyl ether sulfate were added to 50 ml of an electrolysis solution (trade name: ISOTON-II, manufactured by Beckman Coulter, Inc.). The resultant admixture has been subjected to a dispersion treatment for 3 minutes at an ultrasonic frequency of 20 kHz in a supersonic disperser (trade name: UH-50, manufactured by SMT Co., Ltd.) thereby to prepare a test sample for measurement. Then, under conditions of an aperture diameter of 100 μm and the number of particles to be measured is 50000 counts, measurement was conducted on the test sample for measurement by means of a particle size distribution measuring apparatus (trade name: Coulter Multisizer II, manufactured by Beckman Coulter, Inc.) On the basis of the volume particle size distribution of the sample particles, the volume average particle size of the toner was derived.

<Formation of Amorphous Polyester and Crystalline Polyester>

[Formation of Amorphous Polyester A]

In a 5 liter-capacity four-neck flask equipped with a nitrogen introducing tube, a dehydrating tube, an agitator, and a thermocouple, 1750 g of polyoxypropylene (2,2)-2,2-bis(4-hydroxyphenyl) propane, 706 g of terephthalic acid, and 4 g of dibutyltin oxide were put. These substances have been reacted thereinto at 230° C. for 20 hours, and whereafter reacted under a pressure of 8.3 kPa for 1 hour. In this way, there was obtained an amorphous polyester A having an acid value of 11.6 mgKOH/g, a softening point of 100° C., a glass transition temperature of 63° C., the highest temperature of endothermic peak of 67° C., and an index of crystallinity of 1.5.

[Formation of Amorphous Polyester B]

In a 5 liter-capacity four-neck flask equipped with a nitrogen introducing tube, a dehydrating tube, an agitator, and a thermocouple, 873 g of polyoxypropylene (2,2)-2,2-bis(4-hydroxyphenyl) propane, 813 g of polyoxyethylene (2,2)-2,2-bis4-hydroxyphenyl) propane, 435 g of fumaric acid, 4 g of dibutyltin oxide, and 1 g of hydroquinone were put. These substances have been reacted thereinto at 200° C. for 8 hours, and whereafter reacted under a pressure of 8.3 kPa for 1 hour. After that, with the addition of 240 g of trimellitic acid anhydride, further reaction has been induced at 210° C. until the softening point was reached. In this way, there was obtained an amorphous polyester B having an acid value of 4.2 mgKOH/g, a softening point of 149° C., a glass transition temperature of 64° C., the highest temperature of endothermic peak of 67° C., and an index of crystallinity of 2.2.

[Formation of Crystalline Polyester C]

In a 5 liter-capacity four-neck flask equipped with a nitrogen introducing tube, a dehydrating tube, an agitator, and a thermocouple, 826 g of 1,6-hexanediol, 812 g of fumaric acid, 4 g of dibutyltin oxide, and g of hydroquinone were put. These substances have been reacted thereinto at 160° C. for 5 hours. Then, after the temperature was raised to 200° C., they have been reacted for 1 hour, and further reacted under a pressure of 8.3 kPa until the desired crystallinity index was reached. In this way, there was obtained a crystalline polyester C having a softening point of 109° C., the highest temperature of endothermic peak (melting point) of 113° C., and an index of crystallinity of 0.97.

<Production of Toner>

Initially, 50 parts by weight of the amorphous polyester A, 30 parts by weight of the amorphous polyester B, 20 parts by weight of the crystalline polyester C, 5 parts by weight of C.I. Pigment Blue 15:3, 2 parts by weight of a boron compound (LR-147 manufactured by Japan Carlit Co., Ltd.), and, as a release agent, 3 parts by weight of a paraffin wax (HNP-10 manufactured by NIPPON SEIRO Co., Ltd) having a melting point of 75° C. have been mixed together for 10 minutes by HENSCHEL MIXER. The resultant admixture has been melted and kneaded by kneading and dispersion treatment apparatus (KNEADEX MOS 140-800 manufactured by Mitsui Mining Co., Ltd.).

The resultant melt-kneaded product has been cooled down. Then, the kneaded product has been coarsely crushed by a cutting mill, and whereafter pulverized into fine particles by a jet-type pulverizer (Type IDS-2, manufactured by Nippon Pneumatic Mfg. Co., Ltd.). Following the completion of the pulverization, classification has been conducted by using a wind power classifier (Type MP-250, manufactured by Nippon Pneumatic Mfg. Co., Ltd.) to obtain matrix toner particles having a volume average particle size of 6.5 μm.

Next, 100 parts by weight of the thus obtained matrix toner particles were added with, as an external additive, 1.5 parts by weight of fine silica particles that have undergone a surface treatment using hexamethyl disiiazane, the number average particle size of which is 12 nm. The resultant admixture has been agitated for two minutes by an airflow mixer (HENSCHEL MIXER, manufactured by Mitsui Mining Co., Ltd.) under a condition where the head speed of the agitating blade thereof is set at 15 m/sec. In this way, there was produced a toner T.

<Production of Two-Component Developer>

### [Formation of Carrier]

As ferrite raw materials, 50 mol % of iron oxide (manufactured by KDK), 35 mol % of manganese oxide (manufactured by KDK), 14.5 mol% of magnesium oxide (manufactured by KDK), and 0.5 mol % of strontium oxide (manufactured by KDK) have been crushed together for 4 hours in a ball mill to obtain a slurry. The slurry has been dried by a spray drier to obtain perfectly spherical particles. The spherical particles have been calcined at 930° C. for 2 hours by a rotary kiln. The resultant calcined powder has been pulverized into fine particles having an average particle size of 2 μm or below by a wet grinding mill (using steel balls as a pulverization medium). Further, with the addition of 2% by weight of PVA, the slurry was subjected to granulation and drying process by a spray drier, and then calcined properly for 4 hours in an electric furnace under conditions of a temperature of 1100° C. and an oxygen level of 0% by volume. After that, crush and classification have been conducted to obtain ferrite component-made core particles having a volume average particle size of 44 μm and a volume resistivity of 1×10⁹ Ω·cm.

Next, in order to form a first coating layer for covering the core particles, a coating fluid was prepared by dissolving and dispersing, in toluene, 100 parts by weight of silicone resin (number average molecular weight: ca. 15000), 3 parts by weight of carbon back (25 nm in primary particle size, 150 ml/100 g in oil absorbency) as a conductive material, and 5 parts by weight of octylic acid as a curing agent.

The ferrite component-made core particles were covered with the thus prepared coating fluid by a spray coating apparatus, and whereafter the toluene was completely removed through evaporation. In this way, there was produced a carrier K that is 45 μm in volume average particle size, 100% in the percentage of silicone resin coverage, 2×10¹¹ Ω·cm in volume resistivity, and 65 emu/g in saturation magnetization.

[Preparation of Two-Component Developer]

A two-component developer was formed by mixing the carrier K and the toner T, and more specifically by putting 6 parts by weight of the toner T and 94 parts by weight of the carrier K in MACTA MIXER (trade name: Model VL-0, manufactured by Hosokawa Micron Corporation) and mixing and agitating them for 20 minutes.

<Evaluation>

The two-component developer thus formed was charged in the image forming apparatus 1 equipped with the aforestated fixing device 40 to conduct evaluation in terms of low-temperature fixability and hot-offset tendency under environmental conditions of a temperature of 20° C. and a humidity of 65%.

Adjustment was made to the surface potential of the photoreceptor drum 51 and the development bias so that the following image formation conditions set for the image forming apparatus 1 can be fulfilled: a 2 cm-by-2 cm square solid image (100% in density) is printed at the center of a recording paper sheet; the amount of toner in the solid image adherent to the recording paper sheet is 0.5 mg/cm²; and the amount of toner in the non-image portion of the recording paper sheet is kept at a minimum. Moreover, as the fixing condition set for the fixing device 40, the fixing rate was set at 150 mm/sec. Further, A4-size electrophotographic paper (MULTI RECEIVER: manufactured by SHARP DOCUMENT SYSTEMS CORPORATION) was used as the recording paper sheet.

[Low-Temperature Fixability Evaluation]

The strength of fixation of an image sample was evaluated as follows. After the recording paper sheet was folded, with its image-printed surface lying inside, a load was applied thereto by rolling a roller of 850 g back and forth one time while keeping the applied pressure constant. Then, a blow of air was applied to the fold of the recording paper sheet; that is, a parting in the printed image by an air brush to measure the width of a white background line that appears at the fold. An image in which the maximum line width is less than 0.3 mm was rated as being good.

[Hot-Offset Evaluation]

Following the completion of consecutive production of 10 sheets of copies, each of which bears a 2 cm-by-2 cm square solid image (100% in density) located at the center of the recording paper sheet, the presence or absence of a hot-offset phenomenon was checked. Copies in which a solid image printed in a region other than the intended region has an image density of 0.1 or above were rated as incurring a hot-offset phenomenon. Those otherwise were rated as being free from a hot-offset phenomenon.

### Example 1

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 150° C., the temperature detected by the second heating-side temperature detecting portion 75 is 130° C., the temperature detected by the first cooling-side temperature detecting portion 66 is 80° C., and the temperature detected by the second cooling-side temperature detecting portion 76 is 80° C.

### Example 2

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 150° C., the temperature detected by the second heating-side temperature detecting portion 75 is 130° C., the temperature detected by the first cooling-side temperature detecting portion 66 is 75° C., and the temperature detected by the second cooling-side temperature detecting portion 76 is 75° C.

### Example 3

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 150° C., the temperature detected by the second heating-side temperature detecting portion 75 is 130° C., the temperature detected by the first cooling-side temperature detecting portion 66 is 90° C., and the temperature detected by the second cooling-side temperature detecting portion 76 is 80° C.

### Example 4

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 170° C., the temperature detected by the second heating-side temperature detecting portion 75 is 150° C., the temperature detected by the first cooling-side temperature detecting portion 66 is 95° C., and the temperature detected by the second cooling-side temperature detecting portion 76 is 95° C.

### Example 5

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 170° C., the temperature detected by the second heating-side temperature detecting portion 75 is 150° C., the temperature detected by the first cooling-side temperature detecting portion 66 is 110° C., and the temperature detected by the second cooling-side temperature detecting portion 76 is 100° C.

### Example 6

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 170° C., the temperature detected by the second heating-side temperature detecting portion 75 is 170° C., the temperature detected by the first cooling-side temperature detecting portion 66 is 110° C., and the temperature detected by the second cooling-side temperature detecting portion 76 is 110° C.

### Comparative Example 1

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 150° C., the temperature detected by the second heating-side temperature detecting portion 75 is 130° C., the temperature detected by the first cooling-side temperature detecting portion 66 is 115° C., and the temperature detected by the second cooling-side temperature detecting portion 76 is 115° C.

### Comparative Example 2

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 170° C., the temperature detected by the second heating-side temperature detecting portion 75 is 150° C., the temperature detected by the first cooling-side temperature detecting portion 66 is 120° C., and the temperature detected by the second cooling-side temperature detecting portion 76 is 120° C.

### Comparative Example 3

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 150° C., the temperature detected by the second heating-side temperature detecting portion 75 is 130° C., the temperature detected by the first cooling-side temperature detecting portion 66 is 70° C., and the temperature detected by the second cooling-side temperature detecting portion 76 is 70° C.

### Comparative Example 4

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 150° C., the temperature detected by the second heating-side temperature detecting portion 75 is 120° C., the temperature detected by the first cooling-side temperature detecting portion 66 is 65° C., and the temperature detected by the second cooling-side temperature detecting portion 76 is 65° C. The results of evaluation are shown in Table 1.

### Comparative Example 5

The fixing device 40 has been operated under conditions where the temperature control unit 90 effects control of the first heater lamp 67, the second heater lamp 77, the first cooling portion 62, and the second cooling portion 72 so that the temperature detected by the first heating-side temperature detecting portion 65 is 110° C., the temperature detected by the second heating-side temperature detecting portion 75 is 110° C., the temperature detected by the first cooling-side temperature detecting portion 66 is 65° C., and the temperature detected by the second cooling-side temperature detecting portion 76 is 65° C. The results of evaluation are shown in Table 1.

TABLE 1

| | | | Fixing belt surface temperature (° C.) | | | | |
|---|---|---|---|---|---|---|---|
| | | | Temperature of close-to heating portion region | | | | |
| | Melting point of toner | | First heating-side temperature detecting | | Second heating-side temperature | | |
| | constituent component (° C.) | | portion | | detecting portion | | |
| | Melting point | Melting point | | Difference in | | Difference in | Heating |
| | of crystalline | of release | Detected | temperature from | Detected | temperature from | temperature |
| | polyester | agent | temperature | melting point (M1) | temperature | melting point (M1) | difference |
| | (M1) | (M2) | (T1) | [(T1) − (M1)] | (T2) | [(T2) − (M1)] | [(T1) − (T2)] |
| Ex. 1 | 113 | 75 | 150 | 37 | 130 | 17 | 20 |
| Ex. 2 | 113 | 75 | 150 | 37 | 130 | 17 | 20 |
| Ex. 3 | 113 | 75 | 150 | 37 | 130 | 17 | 20 |
| Ex. 4 | 113 | 75 | 170 | 57 | 150 | 37 | 20 |
| Ex. 5 | 113 | 75 | 170 | 57 | 150 | 37 | 20 |
| Ex. 6 | 113 | 75 | 170 | 57 | 170 | 57 | 0 |
| Comp. | 113 | 75 | 150 | 37 | 130 | 17 | 20 |
| Ex. 1 | | | | | | | |
| Comp. | 113 | 75 | 170 | 57 | 150 | 37 | 20 |
| Ex. 2 | | | | | | | |
| Comp. | 113 | 75 | 150 | 37 | 130 | 17 | 20 |
| Ex. 3 | | | | | | | |
| Comp. | 113 | 75 | 150 | 37 | 120 | 7 | 30 |
| Ex. 4 | | | | | | | |
| Comp. | 113 | 75 | 110 | −3 | 110 | −3 | 0 |
| Ex. 5 | | | | | | | |

| | Fixing belt surface temperature (° C.) | | | | | | | | |
|---|---|---|---|---|---|---|---|---|---|
| | Temperature of close-to-cooling portion region | | | | | | | | |
| | First cooling-side temperature detecting | | | Second cooling-side temperature detecting | | | | | |
| | portion | | | portion | | | | | |
| | | Difference in | Difference in | | Difference in | Difference in | | | |
| | | temperature | temperature | | temperature | temperature | Cooling | | |
| | Detected | from melting | from melting | Detected | from melting | from melting | temperature | | Low- |
| | temperature | point (M1) | point (M2) | temperature | point (M1) | point (M2) | difference | Occurrence | temperature |
| | (T3) | [(T3) − (M1)] | [(T3) − (M2)] | (T4) | [(T4) − (M1)] | [(T4) − (M2)] | [(T3) − (T4)] | of hot offset | fixability |
| Ex. 1 | 80 | −33 | 5 | 80 | −33 | 5 | 0 | Absent | Good |
| Ex. 2 | 75 | −38 | 0 | 75 | −38 | 0 | 0 | Absent | Good |
| Ex. 3 | 90 | −23 | 15 | 80 | −33 | 5 | 10 | Absent | Good |
| Ex. 4 | 95 | −18 | 20 | 95 | −18 | 20 | 0 | Absent | Good |
| Ex. 5 | 110 | −3 | 35 | 100 | −13 | 25 | 10 | Absent | Good |
| Ex. 6 | 110 | −3 | 35 | 110 | −3 | 35 | 0 | Absent | Good |
| Comp. | 115 | 2 | 40 | 115 | 2 | 40 | 0 | Present | Good |
| Ex. 1 | | | | | | | | | |
| Comp. | 120 | 7 | 45 | 120 | 7 | 45 | 0 | Present | Good |
| Ex. 2 | | | | | | | | | |
| Comp. | 70 | −43 | −5 | 70 | −43 | −5 | 0 | Present | Good |
| Ex. 3 | | | | | | | | | |
| Comp. | 65 | −48 | −10 | 65 | −48 | −10 | 0 | Present | Good |
| Ex. 4 | | | | | | | | | |
| Comp. | 65 | −48 | −10 | 65 | −48 | −10 | 0 | Absent | Poor |
| Ex. 5 | | | | | | | | | |

As will be apparent from Table 1, Examples 1 through 6, each of which the temperature of the close-to-heating portion region of the fixing belt surface is controlled to he higher than or equal to the melting point of the crystalline polyester and the temperature of the close-to-cooling portion region of the fixing belt surface is controlled to be higher than or equal to the melting point of the release agent but lower than the melting point of the crystalline polyester, have proven that they offer satisfactory low-temperature fixability and are protected against occurrence of a hot-offset phenomenon.

The invention may he embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A fixing device for fixing a toner image, which is formed on a recording medium in a yet-to-be-fixed state and is constituted by a toner containing a binder resin composed of crystalline polyester and amorphous polyester and a release agent having a melting point lower than a melting point of the crystalline polyester, onto the recording medium by bringing about toner-image fusion, comprising:
a fixing belt disposed face to face with a surface of the recording medium having the toner image formed thereon, the fixing belt being an endless belt member which is supported around a plurality of support rollers with tension so as to be driven to turn in accompaniment with a rotation of the support rollers;
a heating portion for applying heat to the fixing belt from the inside so that a surface temperature of the fixing belt becomes a predetermined temperature which is higher than or equal to a melting point of the crystalline polyester; and
a cooling portion located downstream from the heating portion with respect to a direction in which the fixing belt turns, for providing cooling for the fixing belt from the inside so that the surface temperature of the fixing belt becomes a predetermined temperature which is higher than or equal to a melting point of the release agent but lower than the melting point of the crystalline polyester,
the fixing device fixing the yet-to-be-fixed toner image borne on the recording medium into place in a fixing nip region created between the heating portion and the cooling portion in the turning direction of the fixing belt.

2. The fixing device of claim 1, wherein the cooling portion is constructed of a Peltier element, and
the fixing belt is heated by the heating portion with the exploitation of exothermic energy corresponding to the cooling energy produced from the cooling portion.

3. The fixing device of claim 1, wherein the heating portion is disposed within, out of a plurality of the support rollers for supporting the fixing belt therearound with tension, the one disposed on the most upstream side with respect to the turning direction of the fixing belt.

4. The fixing device of claim 1, further comprising a heat insulating member extending in an extending direction of the fixing belt, for covering the fixing belt from its outside.

5. The fixing device of claim 1, further comprising a second cooling portion disposed face to face with the cooling portion, with the fixing belt interposed therebetween, for providing cooling for the fixing belt from its outside so that the surface temperature of the fixing belt becomes a predetermined temperature which is higher than or equal to the melting point of the release agent but lower than the melting point of the crystalline polyester.

6. A fixing method for fixing a toner image on a recording medium by using the fixing device of claim 1.

7. An image forming apparatus provided with the fixing device of claim 1.
